(19) United States
(12) Patent Application Publication
(10) Pub. No.: US 2014/0242399 A1
(43) Pub. Date: Aug. 28, 2014

(54) POLYMER, COMPOSITIONS AND PROCESS FOR PREPARING THEM

(71) Applicant: DSM IP ASSETS B.V., Heerlen (NL)

(72) Inventors: Tijs Nabuurs, Waalwijk (NL); Gerardus Cornelis Overbeek, Waalwijk (NL); Michel Johannes Jan Ruts, Waalwijk (NL); Ronald Tennebroek, Waalwijk (NL)

(73) Assignee: DSM IP ASSETS B.V., Heerlen (NL)

(21) Appl. No.: 14/350,958

(22) PCT Filed: Oct. 25, 2012
(86) PCT No.: PCT/EP2012/071131

§ 371 Date: Apr. 10, 2014

(30) Foreign Application Priority Data
Oct. 27, 2011 (EP) 11186961.6

(51) Int. Cl. C08G 18/38; C09D 175/12

(52) U.S. Cl. CPC C08G 18/3893; C09D 175/12
USPC 428/447; 528/26; 524/588; 427/387

(57) ABSTRACT

There is described a process for preparing an silane-functional oligomer (such as an alkoxysilane polyurethane) suitable for use as a crosslinkable coating component, the process comprising the steps of: 1) reacting an aminoalkyl silane with a cyclic carbonate, lactone or lactam to form a hydroxyl (OH) or imino (NH) functional silane intermediate, 2) reacting the silane intermediate from step 1) (optionally immediately without isolation) with a diisocyanate (diNCO) to form a silane functional polyurethane; where in step 2) the molar ratio of the total amount OH or NH groups on the silane intermediate of step 1) to the diisocyanate is from 1.8 to 2.2 (preferably about 2.0) and the resultant silane polymer is substantially-free of isocyanate groups thereon.

This invention relates to the field of silane functional polymers (such as silane functional polyurethanes), to methods of making them (e.g. by reacting an aminoalkyl silane with a cyclic carbonate, followed by reacting with a diisocyanate), and coating compositions containing them. This invention also relates to the field of a process for coating using the coating compositions (for example clear coats), to coated substrates obtainable by the coating process (for example clear coats on transparent substrates) and to uses of the coated substrates (for example to prepare scratch resistant displays).

Poly(alkoxysilyl)-functional oligomers having hydrolysable silyl groups (also referred to as silane-functional polymers) are known from various publications. Such moisture-curable oligomers can be used in adhesive and coating compositions, like automobile refinish coatings. Coatings obtained typically show high hardness and very good chemical resistance and weatherability, resulting from a three dimensional network of Si—O—Si bridges. Several synthesis routes of poly(alkoxysilyl)-functional oligomers have been described in literature. One approach to obtain such compounds is to react an aminosilane coupling agent having a hydrolysable silane group and a secondary amine group with a polyisocyanate (see for example EP0571073, US2003-027921 or EP2248837). Alternatively, isocyanate functional alkoxysilane can be reacted with hydroxyl-functional prepolymers (as described in US2008-0160200 or US2010-0280209).

Other silane functional polymers comprising aminoalkyl silane, cyclic carbonate and/or polyisocyanate moieties have also been described or are known in the market. However such products or the methods for obtaining them have various disadvantages. The prior art will now be further discussed below.

EP0571073 (ICI) describes a silane functional oligomer which has at least one hydrolysable silane group and which is the reaction product of (i) a silane coupling agent having a hydrolysable silane group and a secondary amine group, (ii) a polyisocyanate having more than one tertiary isocyanate group, and containing at least 6% by weight of NCO groups, and (iii) optionally, a compound having a single isocyanate-reactive group. The oligomers prepared from this process form rigid structures to create hard and brittle coatings as the silane moieties used in stage (i) are inflexible.

EP1273640 (Degussa) describes a non-aqueous, thermal curable coating composition comprising A) a solvent based polyol component and B) a crosslinker, consisting of at least one aliphatic and/or cycloaliphatic polyisocyanate with an NCO functionality of between 2 and 6, wherein 0.1 to 95 mole-% of the original isocyanate groups react with N,N-bis-(3-trialkoxysilylpropyl)amine, in a weight ratio of A) and B) of between 6:1 to 1:2, based on solids content. The resultant compositions are brittle and must be cured by combining two components (so called “2-C” or two part curing). This compares with the compositions of the present invention that may be cured without adding further agents (so called “1-C” or one part curing).

EP2248837 (Fischerwerke) describes adhesives and coatings suitable for use in construction, comprising silane functional polymers prepared by reacting an amino silane with diisocyanate. The resultant polymers form hard and brittle coatings.

EP 2305691 (Bayer) (=US 2011-082273) describes high functional polyisocyanates that contain allophanate and silane groups. They are used a crosslinkers and starting components to make polyurethanes for uses such as paints or coatings.

WO1996-038453 (3M) describes moisture curable alkoxysilane functional polyurethanes prepared from certain hydroxyalkylenecarbamoylalkylene alkoxysilanes. These silane polyurethanes are used as moisture curable adhesives, sealants or putties.

WO1998-018844 (3M) relates to sealant compositions comprising an alkoxysilane-functional (polyether-urethane) made by reacting a hydroxycarbamoyl alkoxysilane precursor with an (equimolar amount of an) isocyanate-functional poly(ether-urethane). The polyether segment in the prepolymer has a molar mass from 2000 to 8000 g/mol.

WO1999-040140 (DuPont) describes a binder comprising a blend of two different oligomers which are curable using silanes. Neither the oligomer nor the binder contains any urethane groups.

WO2009-115079 (NanoX) describes a process for the preparation of an abrasion resistant automotive coating based on silane-functional compounds such as isocyanate terminated alkyl trialkoxysilanes. The examples of this application typically use a commercially available isocyanatopropyl trimethoxysilane (ICTMS) as reactant. A major drawback of using isocyanates is their toxicity. This applies in particular to ICTMS, which is also difficult to make and thus expensive.

WO2009-130298 (=US2011-0034627) (Henkel) discloses poly(alkoxysilyl)-terminated polyurethanes for use in adhesive, sealant or coating compositions, in which polyurethanes are made by firstly reacting aminosilane with ethylene carbonate, propylene carbonate, or butylene carbonate (or a lactone) to form a reactive (hydroxyl-functional) silane, then secondly reacting the product of the first step with an isocyanate-terminated polyurethane prepolymer, preferably at a slight stoichiometric excess of the reactive silane (see paragraph [0050]). The isocyanate-terminated polyurethane is made by reacting a polyol, preferably a polyoxyalkylene, of molar mass from 4000 to 20000 g/mol with excess diisocyanate.

U.S. Pat. No. 5,587,502 (3M) describes that a hydroxycarbamoyl alkoxysilane precursor is prepared by reacting a cyclic carbonate with an aminoalkylene alkoxysilane; for example from propylene carbonate and 3-aminopropyl trimethoxysilane at 1:1 mol ratio. These precursors are prepared using large (molar mass>2000 g/mol) isocyanate-terminated prepolymers as one the reagents.

US2008-160200 (Consortium Elektrochem) describes coating compositions (B) with high hardness containing prepolymers (A) comprising alkoxysilanes and —O—(C═O)—NR groups.

US20090-0326146 (Sepeur et al) describes very generally a non-sol gel process to produce a silane coating comprising one or several non-pre-condensed silanes. In a preferred process silanes (preferably have a molecular mass>300) undergo an organic linking reaction with (homologous or non-homologous) silanes, organic monomers, oligomers and/or polymers as well as 0.5 to 50% by weight of Lewis acid. The coating material thus produced is applied to a substrate and hardened. The examples described are isocyanate-functional silanes.

EP2014692 (Bayer) describes polyisocyanate crosslinkers, comprising allophanate groups and hydrolysable silane groups. The process for making these compounds comprises the steps of i) reacting aminosilane with equimolar amount of cyclic carbonate (or lactone) to form a hydroxyurethane (or hydroxamide), then ii) reacting product of i) with molar excess of a diisocyanate, at NCO/OH ratio 4-50. Excess diisocyanate is preferably removed. In the experiments 3-aminopropyl trimethoxysilane is first reacted with an equimolar amount of ethylene carbonate; the product is then reacted with HDI at NCO/OH ratio 10, 15, or 20. A catalyst is applied to promote allophanate formation. Thus this document teaches that a significant excess of product i) should be used to form allophanate functional isocyanates (NCO functionality>1.6 in all examples). The product is designed for use as a crosslinker so it is a desired feature of the polymeric products described in Bayer that they have significant amounts of free (i.e. reactive) isocyanate groups attached to the polymer.

US2010-0280209 (Henkel) describes curable compounds comprising silylated polyurethanes. The document discloses a process to prepare isocyanate-terminated alkyl trialkoxysilanes which are prepared using large (molar mass>2000 g/mol) isocyanate-terminated prepolymers as one the reagents.

US2011-0082273 (Bayer) only differs from US2009-0018302 (described above) in that in addition to the hydroxyurethane also a further polyhydroxy compound is added, to increase isocyanate functionality of the crosslinker.

The prior art silane polymers and processes for making them are very different from the present invention. For example prior art silane polymers typically contain significant amounts of reactive groups (such as isocyanates), are be prepared from costly ingredients that are difficult to handle and/or are made using difficult, expensive processes.

The use of isocyanate terminated silanes is not desired for many reasons. The process to obtain isocyanate terminated silanes is very complex. As described in the literature (e.g. in U.S. Pat. No. 6,979,745), their preparation requires amongst other things a process step where a methyl-carbamate is heated to 450-500° C. to produce the isocyanate. Secondly the monomers used to prepare such silanes are very toxic. This makes the resultant isocyanate terminated silanes very costly.

It would therefore be useful to provide a process that does not use a complex heating step, does not use extremely toxic raw materials, and/or which would be inherently cheaper than known processes. It would also be useful that the products of such processes would be substantially free of reactive groups such as isocyanate groups and/or be suitably inert for use as a binder in coating compositions.

The object of the present invention is to solve some or all of the problems and/or disadvantages (such as identified herein) with the prior art.

The applicant has now surprisingly found that in one embodiment of the invention by reacting a combination of certain cyclic carbonates, diisocyanates and amino functional silanes for example in certain ratios, products can be obtained (optionally which are substantially free of reactive isocyanate groups) which exhibit a good balance between flexibility and surface hardness, using an inherently easier, cheaper and simpler process than the prior art processes.

Therefore broadly in accordance with the present invention there is provided a process for preparing a silane polymer, the process comprising the steps of:

1) reacting
(i) a first component (=Silane Component I) comprising at least one silyl group(s) and at least one reactive group(s) A (Group A); with
(ii) a second component (=Cyclic Component II) comprising at least one organo cyclic moeit(ies) and at least one reactive group(s) B (Group B) reactive with Group A,
   to form an intermediate product (=Silane Intermediate);

where at least one of the Silane Component I and/or the Cyclic Component II comprise at least one active-reactive group(s) and/or precursors therefor (together also referred to herein as r-grp(s));

where Group A and Group B are selected to react with each other under the conditions of step (1) to form the Silane Intermediate; and

where the Silane Intermediate comprises at least one silyl group(s), at least one organo moeit(ies) derived from the at least one organo cyclic moeit(ies) from Cyclic Component II and at least one r-grp(s); and

2) reacting the Silane Intermediate from step (1) with at least one reagent (=Active-Component III), comprising a plurality of active-groups (=a-grps) to form a polymeric product (=a Silane Polymer) that is substantially free (calculated with respect to Active-Component III) of a-grps;

where in step (2), the total moles of the r-grp(s) on the Silane Intermediate are at least substantially the same as (in one preferred embodiment are in excess of) the total moles of a-grps comprising the Active-Component III.

“At least substantially the same as” (in relation to number of moles in step (2)) means in step (2) the total moles of the r-grps is at least 80%, preferably at least 90%, more preferably at least 95%, most preferably the same as the total moles of a-grps on Active-Component III.

The terms “substantially free of” and “substantially” as used to describe in the process of the invention are also further defined later in this application.

Conveniently in one embodiment of the present invention the Silane Polymer obtained from step 2) is comprises no more than 20%, more conveniently no more than 10%, most conveniently no more than 2% of active groups (percentages calculated by moles of active groups in the Silane Polymer compared to moles of active groups on the Active-Component III in step 2), especially is free of active-groups.

Usefully in another embodiment of the present invention in step (2) the total moles of the active-reactive groups on the Silane Intermediate are the same as or in excess of the total moles of active groups on the Active-Component III.

Advantageously in yet another embodiment of the present invention in step (2) the total moles of the active-reactive groups on the Silane Intermediate are the same as the total moles of active groups on the Active-Component III.

Conveniently in a still other embodiment of the invention in step (2) the molar ratio of the active groups on the Active-Component III to the active-reactive groups on the Silane Intermediate is from 0.8 to 1.2 more conveniently from 0.9 to 1.1, most conveniently from 0.95 to 1.05, in particular from 0.99 to 1.01, for example is 1.0.

Usefully in one alternative further embodiment of the invention in step (2) the molar ratio of the active groups on the Active-Component III to the active-reactive groups on the Silane Intermediate is from 0.8 to below 1.0 (e.g. 0.99), more conveniently is from 0.9 to below 1.0 (e.g. 0.99), most conveniently is from 0.95 to below 1.0 (e.g. 0.99).

Advantageously in different alternative further embodiment of the invention in step (2) the molar ratio of the active groups on the Active-Component III to the active-reactive groups on the Silane Intermediate is from above 1.0 (e.g. 1.01) to 1.2, more conveniently is from above 1.0 (e.g. 1.01) to 1.1, most conveniently is from above 1.0 (e.g. 1.01) to 1.05.

Preferably in a still other embodiment of the present invention the Silane Intermediate obtained from step (1) is substantially free of (preferably free of) active groups (such as isocyanate groups). Without wishing to be bound by any mechanism it is believed that otherwise such active groups might react (e.g. self-react within the same molecule) with the active-reactive groups (r-groups) already present on the Silane Intermediate in step (1) and/or compete with the Active Component III in step (2). Thus r-groups might not then be available (or be available in reduced amounts) in Step (2) to react with the active groups on the Active-Component III. Alternatively any active groups that may be present on the Silane Intermediate obtained from step (1) may, before the Active Component III is added in step (2), undergo a suitable protection reaction to form a suitable protecting group (i.e. which does not react with the r-groups). Where any active groups on the Silane Intermediate are significantly less reactive that those on the Active Component III, such protection may not be needed in step (2), however then it may be preferred that the Active Component III is added to the Silane Intermediate without too much delay i.e. step (2) follows fairly quickly, preferably immediately, after step (1) to reduce the opportunity for self-reaction.

In a still yet other embodiment of the process of the invention where the Silane Intermediate is obtained in step (1) from a Silane Component I consisting of 3-aminopropyltrimethoxysilane, and a Cyclic Component II consisting of propylene carbonate containing a cyclic moiety, where the Cyclic Component II has completely reacted in step (1); and where in step (2) the Active Component III also consists of a NCO-terminated prepolymer obtained by reacting polypropylene glycol and tetramethylxylene diisocyanate (TMXDI) then the amount of Silane Intermediate used in step (2) is such that the active-reactive groups on the Silane Intermediate are in substantially the same as, more preferably exactly the same as the total moles of active groups on the Active-Component III.

The active-reactive groups on the Silane Intermediate in step (1) may be already present in the second component (=Cyclic Component II) or may be formed in situ for example during step (1). Thus suitable Cyclic Component II may also comprise those groups that act (for example under the conditions of step (1)) as a precursors to the desired active-reactive groups on the Silane Intermediate.

Optionally the process of the invention produces polymers suitable for use as a coating binder.

Preferred processes of the invention are those where the resultant polymer (Silane Polymer) obtained from step (2) comprises silyl groups and polyurethane linkages (=Silane Polyurethane), though processes for preparing other silane polymers such as those comprising silyl groups and ester linkages (=Silane Polyester) also form alternative embodiments of the invention.

The groups A and B may be the same or different to respectively the at least one silyl group on component (i) and the at least one organo cyclic moiety on component (ii).

Preferably group A comprises, more preferably consists of, the at least one silyl group on component (i).

Preferably group B comprises more preferably consists of the at least one organo cyclic moiety on component (ii).

Preferably in step (1) at least one silyl group on component (i) (=group A) reacts with at least one organo cyclic moiety on component (ii) (=group B), more preferably by a ring opening of the cyclic moiety, to form the Silane Intermediate.

Reactive-groups (also referred to herein as r-grps) denote any groups that react with the corresponding active-groups (also referred to herein as a-grps) as described herein. Suitable r-grps may comprise r-oxirane, r-NCO and/or r-NH groups, where r-oxirane denotes a group that may react in the process of the invention with oxirane ring groups; r-NCO denotes a group that may react in the process of the invention with isocyanate groups; and r-NH denotes a group than may react in the process of the invention with imino groups. Unless the context clearly indicates otherwise the terms ‘r-grp’ and the like also include suitable groups which act as precursors for groups that directly react with a-grps (e.g. will generate such directly reactive groups under the reaction conditions in step (2)).

Preferred reactive-groups (r-grps) are “Reactive-N” groups which denote any groups that can react with the corresponding active-N groups as described herein. Suitable reactive-N groups (also denoted herein as r-N) may comprise r-NCO and/or r-NH groups, where r-NCO denotes a group that may react in the process of the invention with isocyanate groups; and r-NH denotes a group than may react in the process of the invention with imino groups. If the “r-grp” is a “r-N grp” then the corresponding “a-grp” is a “a-N grp” as defined herein.

Without wishing to be bound by any mechanism it is believed that the cyclic organo moieties substantially react in the first step to form the intermediate and preferably the intermediate itself is substantially free of (more preferably does not contain any) cyclic organo moieties.

There are several embodiments of the process of the invention that may be envisaged and non-limiting examples of some of these embodiments are described below.

In one embodiment the organo cyclic moiety may comprise (conveniently the Cyclic Component II may consist of) cyclic carbonates.

Another embodiment the organo cyclic moiety may comprise (conveniently the Cyclic Component II may consist of) cyclic lactones (optionally unsubstituted), preferably C₄₋₁₀lactones, more preferably C₅₋₆lactones.

In a still further embodiment the organo cyclic moiety may comprise (conveniently the Cyclic Component II may consist of) cyclic lactams, preferably C₄₋₁₀lactams, more preferably C₅₋₆lactams.

In a yet further embodiment the organo cyclic moiety may comprise (conveniently the Cyclic Component II may consist of) cyclic anhydrides and in this embodiment the resultant Silane Intermediate may comprise silyl and carboxyl groups (in which case the r-grp may comprise carboxy). In step (2) in this embodiment Active-Component III may thus comprise a polyoxirane (preferably epoxide, more preferably diepoxide) as the reagent, in which case the Active-grp is an oxirane moiety.

In any of the embodiments described herein the components described therein may comprise a plurality of the relevant functional groups or moieties described therein (e.g. cyclic carbonates may comprise two or more cyclic carbonate moieties either attached directly or via a suitable linking group).

In any of the embodiments described herein the components described therein may comprise a plurality of the different pairs of corresponding functional groups or moieties that react as described therein so that multiple reactions between the various different pairs may also be combined in the same process as a yet other embodiment.

In embodiments where the Cyclic Component II is other than a cyclic carbonate, lactone or lactam and the Active Component III is other than a polyisocyanate then in step (2) the moles of active-reactive groups may not be the same as or in excess of the moles of reactive groups and thus the Silane Polymer obtained may not be free of active groups (though this option is still preferred).

Without wishing to be bound by any mechanism the applicant believes that in general Silane Intermediates obtained from embodiments that use different starting materials will produce a predominance of molecules with different linking groups therein. For example where aminosilane and diisocyanate are used as respective Components I and III, then using lactones as Component II will generally produce two urethane and two amide linkages in the resulting molecule. Using lactams as Component II will generally produce two urea and two amide linking groups in the resulting molecule. Using cyclic carbonates as Component II will generally produce four urethane linkages in the resulting molecule.

In step (2) of the process of the invention the Active-Component III denotes any suitable species that comprises a plurality of active-groups. As used herein active-group (also denoted herein as ‘a-grp’) is a group (optionally comprising nitrogen or oxygen) that will react under the conditions of step (2) with the reactive-groups (r-groups) on the Silane Intermediate to form a silane polyurethane (i.e. silane polymer comprising amide —NH(C═O)— linking groups). Suitable ‘a-grps’ may comprises oxirane rings, NCO and/or imino groups.

In a further embodiment of the process of the invention:

the Cyclic Component II is selected from one or more cyclic anhydride;
the at least one active-reactive group (r-grp) on the Silane Intermediate obtained from step (1) comprises, preferably consists of, oxirane-reactive group(s) (=r-Oxir) (preferably carboxy groups);
the plurality of active-groups on the Active-Component III in step (2) comprises, preferably consists of, two or more oxirane groups (Oxir) (preferably two or more epoxy groups); and
the silane polymer obtained from step (2) is a Silane Polyester; where the molar ratio of the r-Oxir and Oxir groups are such that the Silane Polyester obtained from step (2) is substantially free of Oxir groups thereon.

In step (2) of the process of the invention preferably the Active-Component III is an Active-N-Component III a term that denotes any suitable species that comprises a plurality of active-N groups. An active-N group (also denoted herein as ‘a-N’) is a nitrogen containing group that will react under the conditions of step (2) with the reactive-N groups (r-N groups) on the Silane Intermediate to form a silane polyurethane (i.e. silane polymer comprising amide —NH(C═O)— linking groups). Suitable ‘a-N’ groups may comprise isocyanate groups (also denoted as NCO) and/or imino groups and suitable poly(a-N) reagents may comprise polyisocyanates, poly(imino functional) compounds, compounds having at least one isocyanate group and at least one imino group, and/or suitable mixtures thereof. The poly imino functional compound may comprise amines having at least two —NH— moieties (i.e. polyamines with two or more primary and/or secondary amine moieties).

Without wishing to be bound by any mechanism herein it will be appreciated that in step (2) of the process of the invention Silane Intermediates obtained in step (1) from cyclic carbonate moieties (such as diesters), cyclic mono esters (lactones) and/or cyclic mono amides (lactams) may preferably react with NCO groups. Therefore it is more preferred that where the Cyclic Component II in step (1) comprises a cyclic carbonate, a lactone and/or a lactam the Active-N-Component III in step (2) comprises a polyisocyanate (e.g. diisocyanate).

Where the Cyclic Component II in step (1) comprises a cyclic carbonate the Active-N-Component III in step (2) may comprise a poly (imino functional) compound (e.g. diamine).

Without wishing to be bound by any mechanism it is believed that the Silane Component I (e.g. a silane compound such as aminosilane) will react with the Cyclic Component II such that the organo cyclic moiety (e.g. cyclic structures such as cyclic carbonates, lactones or lactams) will undergo ring opening. Thus in embodiments of the invention where the cyclic structure is a cyclic carbonate it is believed that the Silane Intermediate from step (1) will comprise a urethane linkage and hydroxyl functionality. Where the cyclic structure is a (cyclic) lactone it is believed that the Silane Intermediate will comprise an amide linking group and hydroxy functionality. Where the cyclic structure is a (cyclic) lactam it is believed that the Silane Intermediate will comprise a amide linking group and amine functionality. The Silane Intermediate produced from step (1) of all three of the preceding embodiments may react with a polyisocyanate (e.g. diisocyanate) in step (2). In general most Silane intermediates produced from lactones or lactams do not readily react with imino groups so it is preferred that for these embodiments the active-N-groups (of the Active-N-Component III) in step (2) are other than imino, more preferably are NCO.

Preferred Silane Polyurethanes of the invention are polymers of a low molecular weight (may optionally be oligomers as described herein) and optionally the components used to prepare them (e.g. Silane Component I, Cyclic Component II and/or N-Active Component III) will be small organic molecules and/or polymeric materials also of low molecular weight which for example will be lower than the values for the number average molecular weight given herein for their resultant silane polyurethane products. Conveniently Components I, II and III individually have a molar mass (if polymeric a number average molecular weight denoted as Mn) each less than 2000 daltons.

Usefully the Silane Polyurethanes of the invention have a number average molecular weight, Mn, (e.g. as calculated theoretically using the Fox equation) of less than 50000 daltons, more usefully less than 20000 daltons, most usefully less than 10000 daltons for example less than 5000 daltons.

An embodiment of the invention comprises a process and product thereof as described herein where the Silane Polyurethane is obtained using a cyclic carbonate and a polyisocyanate. The second embodiment has the advantage of using cheap and readily available raw materials and reaction steps (1) and (2) may proceed smoothly. However the second embodiment may have the tendency to produce a product which contains isocyanate groups unless the molar ratio of NCO to r-NCO groups is carefully controlled.

It is preferred that step (2) is performed sequentially and preferably substantially immediately after step (1), optionally in the same vessel, where the intermediate from step (1) is not isolated but is used directly in the next step. If step (2) is not performed immediately or substantially immediately after step (1) conveniently step (2) is begun within a period of 480 minutes more conveniently 180 minutes, usefully 120 minutes from the end of step (1), more usefully within 60 minutes, most conveniently within 30 minutes, for example within 20 minutes. The steps (1) and (2) may also be performed simultaneously where the reaction in step (1) occurs to generate intermediate whilst at the same time the intermediate product is also being reacted with the polyisocyanate or polyfunctional amine in step (2).

The period over which step (2) may be performed may vary according to many factors such as the absolute amount of ingredients to be added (especially if the process is conducted on a large scale on an industrial plant). However it is still preferred that there is not a long delay between the end of step (1) and the beginning of step (2). Without being bound by any mechanism it is believed that too long a delay between steps (1) and (2) provides time for the Silane Intermediate from step (1) to react to form species comprising (if Group A or B is hydroxy) “—Si—X—Si—X—OH” moieties (where X denote linking groups or direct bonds) which can then react with the isocyanate in step (2) to form “—Si—X—Si—X—Si—’ moieties in the final product. The final product will also be advantageously hard but may then become highly viscous. So by reducing the period for which the Silane Intermediate is ‘held’ at the end of stage (1) reduces the viscosity of the product and prevents the reaction mixture from gelling.

Component (i) may comprise: any OR, —SH, OH and/or NH functional organo silane (e.g. aminoalkyl silane or hydroxyalkyl silane) and/or any suitable mixtures thereof.

Reactive group A may be selected from silyl, primary amine, secondary amine, thiol, hydroxyl, alkoxy groups, and/or any suitable combinations thereof attached to the same or different moieties.

Component (ii) may be selected from an organic moiety comprises one or more ˜Y(C═O)Y˜ moieties (preferably ˜O(C═O)Y˜ moieties, more preferably ˜O(C═O)O˜, ˜(C═O)O˜ and/or ˜(C═O)NH˜ moieties, most preferably ˜O(C═O)O˜ moieties); one or more organo ring moieties (optionally which may be the same as the ˜Y(C═O)Y˜ moieties) and/or any suitable mixtures thereof.

In the ˜Y(C═O)Y˜ group one of the two Y substituents may represent a linking bond, or ˜C(R)₂˜ (where each R independently represents, H or optionally substituted C₁₋₁₀hydrocarbo, preferably H or C₁₋₆alkyl), in which case the other Y will represent either an oxy (˜O˜) or ˜NR˜ (preferably imino, ˜NH˜) and the ˜Y(C═O)Y˜ group represents respectively a mono ester group or an amide group. Alternatively both Y substituents may be oxy groups in which case the ˜Y(C═O)Y˜ group represents a carbonate group.

If the ˜Y(C═O)Y˜ group is part of a ring the organic moiety may form part or whole of a cyclic carbonate, cyclic mono ester (i.e. lactone) or cyclic mono amide (i.e. lactam).

Reactive group B may be selected from ˜Y(C═O)Y˜, preferably ˜(C═O)O˜, ˜(C═O)NH˜ and/or ˜O(C═O)O, more preferably ˜O(C═O)O˜, attached to the same or different moieties.

The Silane Intermediate (from step (1)) may comprise: silyl groups attached to any OR, —SH, OH and/or, —NH and one or more ˜Y(C═O)Y˜, organo ring moieties and a rNCO group (if not already present) and/or any suitable combinations and/or suitable mixtures thereof. Preferred are NH₂ and NRH (where R is independently as denoted above).

The isocyanate reactive group(s) (rNCO) may be selected from: any active hydrogen containing species and/or any suitable combinations thereof attached to the same or different moieties.

Preferably in step (2) the molar ratio of the rNCO groups on Intermediate (1) to the NCO groups on the polyisocyanate (i.e. a species comprising ‘n’ NCO groups where n is ≧2) is in the range from 1 to n. More preferably when the polyisocyanate is a diisocyanate (i.e. n is 2) this molar ratio (rNCO to NCO) is from 1 to 2. Usefully the silane polyurethane product from step (2) is substantially-free of isocyanate groups.

The terms ‘Silane’, ‘Silane Intermediate’, ‘Silane Polymer’, ‘Silane Poluyurethane’ and/or Silane Polyester” (and similar terms) as used herein whether referring to compounds, molecules, macromolecules, oligomers or polymers used in or of the present invention is meant to encompass a broad range of compounds, from relatively low molar mass compounds to oligomers and/or prepolymers having molar mass in the range of for example from 500 to 100000 g/mol, typically depending on the chemical structure of the polyfunctional compound and the number of silyl groups therein.

Optionally one other aspect of the present invention provides a process for preparing an alkoxysilane-functional oligomer suitable for use as a crosslinkable coating component, the process comprising the steps of:
1) reacting an aminoalkyl silane with a cyclic carbonate to form a hydroxyl functional intermediate, and (optionally immediately without isolation of the intermediate)
2) reacting the OH functional intermediate product of 1) with a diisocyanate to form a silane functional polyurethane oligomer;
   where optionally in step 2) the molar ratio of the OH groups present in the product of step 1) to the NCO groups on the diisocyanate is in the range 1 to 2 and further optionally where the product from step (2) is substantially-free of isocyanate groups thereon.

A further aspect of the invention broadly provides a product obtained or obtainable from the process of the invention as described herein.

As used herein reactive isocyanate groups (also referred to herein as rNCO) means groups that are capable of reacting with isocyanate under the conditions specified herein.

In one embodiment of the invention the silane polyurethane product from step 2 of the process of the invention (the Product) is substantially free of NCO. The terms ‘substantially’ and ‘substantially-free’ are both defined in this application.

In another embodiment of the invention the Product may comprises at least 10%, usefully >=20%, more usefully >=30%, for example >=50% by weight, preferably substantially comprises by weight, molecules in which the NCO groups have completely reacted with the isocyanate reactive groups (rNCO) comprising the Silane Intermediate (e.g. obtained from step 1 of the invention).

Isocyanates can undergo characteristic reactions with species containing active hydrogen (examples given in bold below):

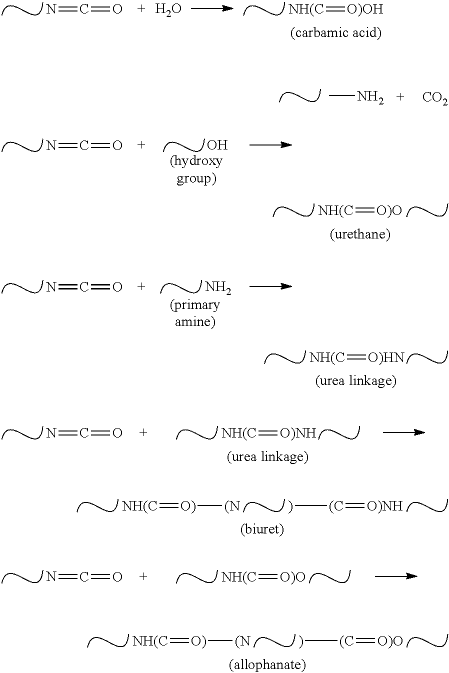

Active-hydrogen as used herein includes any species that may react with isocyanate containing species in the above reactions plus any others known to those skilled in the art (such as acetocarbonyl moieties).

The embodiments of the process of the invention where a cyclic carbonate, cyclic ester or cyclic amide react with a functional silane (e.g. amino silane) in step (1) can proceed readily at low temperatures. Preferred temperatures of step (1) are from 0 to 150° C., more preferably from 10 to 100° C., even more preferably from 15 to 70° C., and most preferably from 15 to 55° C. Preferably step (1) is performed in the absence of solvent, although if the viscosity of the reaction mixture becomes too high a solvent can be used in which cases non-protic solvents are preferred. When such volatile components are used optionally step (1) can be performed under elevated pressure in a high pressure reactor.

Step (2) (reaction of r-NCO functional Silane Intermediate with polyisocyanate) is preferably performed at a temperature from 50 to 200° C., more preferably from 60 to 150° C., most preferably from 70 to 125° C.

Either or both of Steps (1) and (2) may proceed readily in the absence of a catalyst. However catalysts can be useful especially in Step (1) where the aminosilane comprises a secondary amine group or in Step (2) (where generally catalysis is preferred). In those cases suitable catalysts (which may be the same or different for each step) may comprise triazabicyclodecene (TBD), metal based catalysts such as tin catalysts, like dibutyl tin laurate, stannous octoate, zirconium based catalysts, titanium based catalysts and/or any other type that is used in polycondensation or urethane synthesis.

The silane component (Component (i)) can comprise any of the following moieties described below.

Conveniently the silanes are those that comprise one or more silo groups and one or more C₁₋₁₀hydrocarbo groups optionally substituted with one or more —NH₂, —NH(C₁₋₁₀hydrocarbo, —SH and/or —S(C₁₋₁₀hydrocarbo)) and/or C₁₋₆hydrocarbyloxy groups.

More convenient silanes are those that comprise one to three silyl groups each optionally substituted by one to four groups selected from: C₁₋₁₀hydrocarbylene (substituted with one or more —NH₂, —NH(C₁₋₆alkyl) and/or —SH) and/or C₁₋₆alkoxy.

Most convenient silanes are those that comprise one to two silyl groups each substituted by two to four groups selected from: C₁₋₁₀alkylene (substituted with one to two —NH₂, —NH(C₁₋₆alkyl) and/or —SH) and/or C₁₋₆alkoxy.

Suitable silanes can comprise primary amine, secondary amine, thiol and/or hydroxyl functional groups, preferably primary and/or secondary amines and/or thiols, for example primary and/or secondary amines.

Suitable silanes comprise a plurality of alkoxy groups, preferably two or more C₁₋₄alkoxy groups, more preferably two or three methoxy and/or ethoxy groups.

Other examples of suitable aminosilanes include, 3-aminopropyltrimethoxysilane, 3-aminopropyltriethoxysilane, 3-aminopropylmethyldimethoxysilane, 3-aminopropylmethyldiethoxysilane, 3-aminopropylethyldiethoxysilane, 3-aminopropyldimethylethoxysilane, 3-aminopropyldiisopropylethoxysilane, 3-aminopropyltripropoxysilane, 3-aminopropyltributoxysilane, 3-aminopropylphenyldiethoxysilane, 3-aminopropylphenyldimethoxysilane, 3-aminopropyltris(methoxyethoxyethoxy)silane, 2-aminoisopropyltrimethoxysilane, 4-aminobutyltrimethoxysilane, 4-aminobutyltriethoxysilane, 4-aminobutylmethyldimethoxysilane, 4-aminobutylmethyldiethoxysilane, 4-aminobutylethyldimethoxysilane, 4-aminobutylethyldiethoxysilane, 4-aminobutyldimethylmethoxysilane, 4-aminobutylphenyldimethoxysilane, 4-amino-butylphenyldiethoxysilane, 4-amino(3-methylbutyl)methyldimethoxysilane, 4-amino(3-methylbutyl)methyldiethoxysilane, 4-amino(3-methylbutyl)trimethoxysilane, 3-aminopropylphenylmethyl-n-propoxysilane, 3-aminopropylmethyldibutoxysilane, 3-aminopropyldiethylmethylsilane, 3-aminopropylmethylbis(trimethylsiloxy)silane, 11-aminoundecyltrimethoxysilane, N-methyl-3-aminopropyltriethoxysilane, N-(n-butyl)-3-aminopropyltrimethoxysilane, N-(2-aminoethyl)-3-aminopropyltrimethoxysilane, N-(2-aminoethyl)-3-aminoisobutylmethyldimethoxysilane, N-(2-aminoethyl)-3-aminopropylmethyldimethoxysilane, N-(2-aminoethyl)-3-aminopropyltris(2-ethylhexoxy)silane, N-(6-aminohexyl)-3-aminopropyltrimethoxysilane, N-benzyl-N-(2-aminoethyl)-3-aminopropyltrimethoxysilane, bis(3-trimethoxysilylpropyl)amine, bis(3-triethoxysilylpropyl)amine, (aminoethylaminomethyl)phenethyltrimethoxysilane, 3-(m-amino-phenoxy)propyltrimethoxysilane, m- and/or p-aminophenyltrimethoxysilane, 3-(3-aminopropoxy)-3,3-dimethyl-1-propenyltrimethoxysilane, 3-aminopropylmethylbis(trimethylsiloxy)silane, 3-aminopropyltris(trimethylsiloxy)silane, 3-aminopropylpentamethyldisiloxane, N,N-bis-(3-trialkoxysilylpropyl)-amine or any desired mixture of such aminosilanes.

Specific examples of silanes suitable for use in the present invention comprise: aminoethylaminopropyl trimethoxysilane (such as that available commercially from Dow Corning under the trade designation Z-6094 SILANE); aminoethylaminopropyl trimethoxysilane (such as that available commercially from Dow Corning under the trade designation Z-6121 SILANE), aminoethylaminopropyl trimethoxysilane (such as that available commercially from Dow Corning under the trade Z-6020 SILANE), mercaptopropyl trimethoxysilane (such as that available commercially from Dow Corning under the trade designation Z-6062 SILANE), bis(3-triethoxysilyl-propyl) amine (such as that available commercially from Degussa under the trade designation Dynasylan 1122), 3-aminopropyl-methyldiethoxysilane (such as that available commercially from Degussa under the trademark Dynasylan® 1505), 3-aminopropyltri-ethoxysilane (such as that available commercially from Degussa under the trademark Dynaylan® AMEO), 3-aminopropyltri-methoxysilane (such as that available commercially from Degussa under the trademark Dynasylan® AMMO) and/or suitable mixtures thereof.

Step (1) of the invention may uses as reaction component at least one organic compound that contains a carboxyoxy, carbonyloxy or carbonylimino moiety and at least one cyclic moiety (preferably together in the same ring). Preferred cyclic compounds comprise cyclic carbonates (i.e. a cyclic diester of a dicarbonic acid); lactones (i.e. a cyclic mono ester of a carbonic acid), lactams (i.e. a cyclic mono amide of a carbonic acid) and/or mixtures thereof. Compounds comprising more than one ring (e.g. bicyclic compounds) may also be used. Preferably the cyclic carbonate, lactone and/or lactam is used in step (1) in molar excess so all the reactive groups in the silane component (I) have reacted.

Convenient cyclic compounds used in the invention may be at least one cyclic carbonate, lactone and/or lactam may be represented by formula:

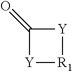

wherein each Y is independently as described herein (with at least one Y being —O—) and R₁ is a divalent optionally substituted organo linking moiety that together with the ˜Y(C═O)Y˜ moiety forms a ring. Preferably both Y are —O—, and R₁ represents a C₁₋₁₀hydocarbo, more preferably C₂₋₆hydrocarbylene, most preferably a C₂₋₄alkylene moiety.

Without wishing to be bound by any mechanism it is believed that the cyclic carbonates lactones and/or lactams as described herein can react quickly and/or at relatively low temperatures in the process of the invention under the conditions described herein. It is also believed that in the final product the cyclic component undergoes ring opening to forms a linear spacer group between two fixed points at the silicon atoms in the cured coating network (with Si—X bonds). This may help to improve the balance between flexibility and hardness of the final coating as the Si bonds provide the hardness and the spacer the flexibility. The balance of both flexibility and hardness in the coatings of the invention results in improved scratch resistance.

Preferred cyclic carbonates, lactones and/or lactams are those comprising four to seven member organo ring moieties, more preferably 5 or 6 membered cyclic moieties (i.e. where the ˜Y(C═O)Y˜ moiety forms part of the ring and there are 3 or 4 carbon atoms in the ring).

A preferred cyclic carbonate moiety is denoted by the following structure (where the asterisk denotes where the cyclic carbonate moiet(ies) attach to the rest of the molecule:

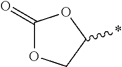 [SMILES: *C1COC(=O)O1]

(which moiety is also referred to herein, as Cyclic Carbonate or Carbonate for short).

However without wishing to be bound by any mechanism it is not believed that the substituent on the Carbonate has a very significant effect on the final properties of the products and coatings of the invention and so the substituent may be for example any alkyl and/or alkoxy such as ethyl, propyl and/or methoxy.

Examples of suitable alkyl groups that may be attached to the ring of the cyclic carbonates, lactones and/or lactams used in the present invention are those selected from the group consisting of: methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl, n-heptyl, n-octyl, pinacyl, adamantyl, the isomeric menthyls, n-nonyl, combinations thereof on the same moiety and mixtures thereof on different moieties.

Preferred cyclic carbonates comprise optionally substituted C₁₋₁₀hydrocarbylene Carbonates. Suitable cyclic carbonates may usefully comprise ethylene Carbonate, propylene Carbonate, mixtures thereof and/or substituted analogues thereof (e.g. with one or more of the aforementioned alkyl groups). More useful cyclic carbonates comprise ethylene Carbonate, propylene Carbonate, 1,2-propylene Carbonate and/or glycerol Carbonate. Most useful cyclic carbonates comprise ethylene Carbonate and/or 1,2-propylene Carbonate.

Suitable examples of cyclic carbonates include 1,3-dioxolan-2-one (ethylene Carbonate), 4-methyl-1,3-dioxolan-2-one (propylene Carbonate), 4-ethyl-1,3-dioxolan-2-one, 4,5-dimethyl-1,3-dioxolan-2-one, 4,4-dimethyl-1,3-dioxolan-2-one, 4-hydroxymethyl-1,3-dioxolan-2-one (glycerol Carbonate), 4-phenoxymethyl-1,3-dioxolan-2-one, 1,3-dioxan-2-one (trimethylene Carbonate), 5,5-dimethyl-1,3-dioxan-2-one, 5-methyl-5-propyl-1,3-dioxan-2-one, 5-ethyl-5-(hydroxymethyl)-1,3-dioxan-2-one (TMP Carbonate), 4-isopropyl-5,5-dimethyl-1,3-dioxan-2-one (2,2,4-trimethylpentane-1,3-diol Carbonate), 4-tert-butyl-5-methyl-1,3-dioxan-2-one (2,4,4-trimethylpentane-1,3-diol Carbonate), 2,4-dioxaspiro[5.5]undecan-3-one (cyclohexane-1,1-dimethanol spirocarbonate) or any desired mixtures of such cyclic carbonates.

A special example of a suitable cyclic carbonate is a polymer or oligomer containing multiple cyclic carbonate pending groups, as for example obtained via reaction of the hydroxyl groups of a polyol with glycerol carbonate.

Preferred cyclic carbonates for use in the process according to the invention are ethylene carbonate, propylene carbonate, and glycerol carbonate; most preferably ethylene carbonate or propylene carbonate are used, in view of their reactivity and removal of liberated compounds.

Suitable polyisocyanates for use in the second step [step (2)] of the process of the present invention comprise: aliphatic, cycloaliphatic, araliphatic, aromatic and/or polyisocyanates and these may be modified by the introduction of urethane, allophanate, urea, biuret, carbodiimide, uretonimine, urethdione or isocyanurate residues. The polyisocyanate can be a diisocyanate or triisocyanate. Preferred polyisocyanates are diisocyanates.

Conveniently di-isocyanate may comprises any of the following and/or suitable mixtures thereof:

ethylene diisocyanate, hexamethylene diisocyanate (HDI), isophorone diisocyanate (IPDI), cyclohexanediisocyanate, dicyclohexylmethane diisocyanate, xylylene diisocyanate, tetramethylxylene diisocyanate (TMXDI), phenylene diisocyanate, toluene diisocyanate (TDI), diphenylmethane diisocyanate, polymethylene polyphenyl polyisocyanates, diphenylmethane diisocyanate, isocyanatomethyl-1-methyl cyclohexyl isocyanate, naphthylene diisocyanate, methylene diphenyl diisocyanate (MDI), hydrogenated methylene diphenyl diisocyanate (hydrogenated MDI), isocyanatomethyl-methyl-cyclohexylisocyanate and mixtures thereof.

More conveniently di-isocyanate may comprises ethylene diisocyanate, 1,6-hexamethylene diisocyanate, IPDI, cyclohexane-1,4-diisocyanate, 4,4′-dicyclohexylmethane diisocyanate, p-xylylene diisocyanate, α,α′-tetramethylxylene diisocyanate, 1,4-phenylene diisocyanate, 2,4-toluene diisocyanate, 2,6-toluene diisocyanate, 4,4′-diphenylmethane diisocyanate, polymethylene polyphenyl polyisocyanates, 2,4′-diphenylmethane diisocyanate, 3(4)-isocyanatomethyl-1-methyl cyclohexyl isocyanate (IMCI), bis(4-isocyanotocyclohexyl) methane (such as that available commercially from Bayer under the trade mark Desmodur® W (also referred to herein as DesW)—DesW is also known as 4,4′-methylenedicyclohexyl diisocyanate, dicyclohexylmethane diisocyanate PICM, hydrogenated MDI (HMDI or H12MDI), saturated MDI (SMDI) or reduced MDI (RMDI))), 1,5-naphthylene diisocyanate, TDI, hydrogenated MDI and/or mixtures thereof.

Most conveniently the polyisocyanates comprise isophorone diisocyanate, 4,4′-dicyclohexylmethane diisocyanate, 4,4′-diphenylmethane diisocyanate, HDI, TMXDI, hydrogenated MDI, DesW and/or mixtures thereof.

Advantageously in one embodiment of the invention the polyisocyanates are substantially free of aromatic groups. Without wishing to be bound by any theory it is believed that aliphatic polyisocyanates produce products of the invention that are more flexible (than for example those made from similar aromatic polyisocyanates).

Polyisocyanates can be used in the pure form. It can be envisaged, however, that using mixtures of polyisocyanates can be beneficial for achieving the desired film properties.

Using solvent is an option, although this is not preferred. The solvent can be used during the reactions or added afterwards to reduce viscosity. It is also possible to use suitable solvents during the reaction that are inert towards the reactive groups of the starting components, or to add a solvent afterwards. If the solvent is added before or during the reaction process, the preferred solvents will be non-protic. In those cases that the solvent is added afterwards these solvents can be protic or non-protic.

The most preferred solvents for storing the Product of the invention (e.g. silane polyurethanes) are protic ones, especially ethanol or methanol. Without wishing to be bound by any mechanism herein, it is believed that the shelf life of the silane functional polymers of the invention may be improved by adding even small amounts of protic solvents (such as alcohols). The preferred solvents that may be used with the Silane Intermediate before step (2) may still be non-protic as described herein.

Examples of suitable solvents that can be used during the reactions are conventional, typical paint solvents, such as ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, aromatics with relatively high degrees of substitution, such as commercially available, for example, under the names solvent naphtha, Solvesso™, Isopar™, Nappar™ (Exxon Chemical) and Shellsol™ (Shell Chemie), but also solvents such as propylene glycol diacetate, diethylene glycol dimethyl ether, dipropylene glycol dimethyl ether, N-methylpyrrolidone and N-methylcaprolactam, or any desired mixtures of such solvents.

Solvents that can be added afterwards include the same, propylene glycol diacetate, diethylene glycol ethyl and butyl ether acetate, and butyl ether acetate.

Preferred polyisocyanates used in the process of the present invention have a molar mass of less than 2000 g/mol, more preferably less than 1000 g/mol, most preferably less than 500 g/mol for example less than 300 g/mol.

In one embodiment of the invention the poly(a-N) reagent may comprise a poly(imino functional)amine, preferably a diamine. Suitable diamines may for example also comprise cyclic and/or aromatic hydrocarbo groups however more preferred diamines comprises alkyl and alkylene groups.

Usefully the diamine may be a diaminoC₂₋₆alkane≡C₂₋₆alkylene diamine, preferably the diamine is unsaturated and/or linear and/or both the amino groups are located on different terminal carbons at ends of the alkylene chain.

Preferred diamines are free of secondary amine groups (—NHR where R is hydrocarbo)

Other suitable polyamine reagents that may be used in some embodiments of the process of the present invention (e.g. as the Active-N Component III) include ethylene diamine, 1,2- and 1,3-propane diamine, 2-methyl-1,2-propane diamine, 2,2-dimethyl-1,3-propane diamine, 1,3- and 1,4-butane diamine, 1,3- and 1,5-pentane diamine, 2-methyl-1,5-pentane diamine, 1,6-hexane diamine, 2,5-dimethyl-2,5-hexane diamine, 2,2,4- and/or 2,4,4-trimethyl-1,6-hexane diamine, 1,7-heptane diamine, 1,8-octane diamine, 1,9nonane diamine, 1,10-decane diamine, 1,11-undecane diamine, 1,12dodecane diamine, 1-amino-3-aminomethyl-3,5,5-trimethyl cyclohexane, 2,4- and/or 2,6-hexahydrotoluylene diamine, 2,4′- and/or 4,4′-diamino-dicyclohexylmethane, 3,3-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 1,3- and/or 1,4-cyclohexane diamine, 1,3-bis(methylamino)-cyclohexane, 1,8-p-menthane diamine, 4,4′-diaminodiphenyl methane

More preferred diamines are selected from:

ethylene diamine (C₂)≡1,2 diamino ethane;
putrescine (C₄)≡1,4-butane diamine≡tetraamethylene diamine≡1,4-diaminobutane ≡DAB≡

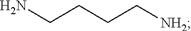

### MPMD≡

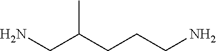

≡1,5-2-methylpentanediamine≡2-methylpentamethylenediamine, (such as that available commercially from Invista under the trade mark Dytek® A);

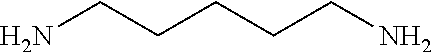

≡cadaverine (c₅)≡1,5-pentanediamine≡pentamethylene diamine;

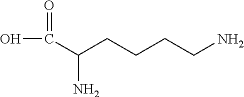

lysine≡ ≡1,5-2-carboxypentanediamine (C₅)

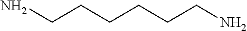

≡hexamethylene-diamine (C₆) (HMDA);

mixtures thereof; salts thereof and/or different suitable forms thereof (such one or more of those forms described later herein, for example such as sterioisomers and enantiomers).

Silane functional polyurethanes of the invention may be prepared in a suitable manner by reacting suitable organic poly-isocyanates (such as those described herein) with silanes comprising r-N reactive groups (such as isocyanate reactive (NCO-reactive) groups) (such as those prepared from step (1) of the process of the invention as described herein) preferably so that the Product from step (2) (or a proportion (preferably a substantial proportion thereof) of the macromolecules that form this Product) are substantially-free of NCO groups.

Preferably the silane polyurethane comprises macromolecules comprising hexavalent Si (i.e. a moiety with a “Si—X—Si” (where X is a linking group or a direct Si—Si bond) where there are potentially three valences on each silicon available to be attached to other groups such as described herein).

The organo moeit(ies) derived from the organo cyclic moiety in the cyclic component II used in step 1 of the process herein usefully may be formed by ring opening during step (1) of the process. These derived organo moeit(ies) may comprise suitable linear linkages that optionally improve flexibility of the Silane Polymer obtained from step (2) (and/or films and/or coatings formed therefrom).

In one embodiment of the process of the present invention the molar ratio of NCO-reactive to NCO groups is maintained as described herein. By analogy the molar ratio of “r-N” to “a-N’ groups and/or the ratio of “r-grps’ to “a-grps” in those other embodiments of the invention described herein may also be selected from any of the values given herein for the r-NCO to NCO molar ratios. Also by analogy the product of such embodiments may be similarly substantially-free of “a-grps” or “a-N groups” in the low (or zero) amounts as stated herein as preferred for NCO-free.

The isocyanate reactive groups may be any suitable active hydrogen containing groups, for example hydroxyl, primary amine and/or secondary amine groups.

Preferred silane functional polyurethanes, may be prepared directly by reacting the reactants (for example in the second step of the process of the invention) in proportions corresponding to a ratio of isocyanate groups (NCO) (for example on the polyisocyanate component) to isocyanate-reactive groups (rNCO) (for example on the silane obtained from the first step of the process of the invention) such that under the conditions of the reaction the resultant silane functional polyurethane obtained is substantially free of NCO groups, and this may be achieved for example by using an excess of rNCO in stage two, so the NCO fully reacts.

Preferably the molar ratio of NCO to rNCO in step two of the process of the invention is kept below a respective ratio of 1.0:1, more preferably ≦0.9:1, most preferably ≦0.85:1 and especially ≦0.75:1 so the r-NCO is always in excess.

As the isocyanate group is moisture sensitive (reacts with water) and some water is often present in the conditions of the reaction and/or in the environment, it will be appreciated that a substantially NCO free final product may be achieved even when slightly less than a stoichiometric excess of r-NCO is used in the process as for example a small amount of NCO groups in the final product will react with ambient water.

Thus in another embodiment of the invention conveniently the molar ratio of NCO to rNCO in step two of the process of the invention may be in the range from 0.8 to 1.2 more conveniently from 0.9 to 1.1, most conveniently from 0.95 to 1.05.

It is especially preferred that the NCO to rNCO (e.g. NCO to OH) ratio is maintained at about 1.0 to produce Silane Polyurethanes with good properties for the end uses described herein. For example when Component III is a diisocyanate the ratio in step (2) of moles of OH in the Silane Intermediate to moles of diisocyanate may be from 1.8 to 2.2, preferably from 1.9 to 2.1, more preferably from 1.95 to 2.05 most preferably about 2, for example equal to 2.0.

Preferred silane functional polyurethanes of the invention have an amide group content (defined as the presence of NH—C═O or N—C═O in mmoles/100 g of solid silane functional polyurethane) of at least 100 mmoles/100 g, more preferably at least 200 mmoles/100 g, most preferred at least 250 mmoles/100 g and especially 350 mmoles/100 g.

In addition, preferred silane functional polyurethanes have a amide group content (defined as the presence of NH—C═O or N—C═O in mmoles/100 g solid silane functional polyurethane) of less than 800 mmoles/100 g, more preferably less than 700 mmoles/100 g, most preferably less than 650 mmoles/100 g, and especially less than 600 mmoles/100 g.

In a yet further aspect of the invention there is provided a silane polyurethane polymer obtained or obtainable from the process of the invention characterised in that the proportion of NCO-free molecules is at least 50%, preferably at least 80%, more preferably at least 85%, even more preferably at least 90%, most preferably at least 95%, especially at least 98%, for example about 100%

The proportion of NCO-free molecules (also referred to herein as “NCO-free percent”) denotes the number of macromolecules obtained by the polymerisation process of the invention that do not comprise NCO groups thereon expressed as a proportion (i.e. a percentage) of the total number macromolecules produced by the polymerisation (i.e. that form the direct polymer product thereof).

The ‘NCO-free percent” may be determined by any suitable means. For example by titration, use of MNR or other spectrographic methods (such as UV, FTIR etc.). One suitable technique is liquid chromatography—mass spectroscopy (LC-MS).

In one embodiment of the invention the ‘NCO-free percent” is determined from a measurement from the FTIR of the Product of the invention the ratio of the FTIR peaks from NCO with respect to total peak area of the FITR or alternatively from a ratio of the FTIR peaks from the NCO to the FTIR peaks from amide (i.e, PU) groups.

FITR peaks denotes the area under those peaks in a Fourier transform infrared (FITR) spectrum (FITR) characteristic for vibrations of the given species coupled to the relevant organo substituents. A FITR ratio is a dimensionless ratio calculated by dividing a first area given by first FITR peaks for a first species by a second area given by second FITR peaks for a second species and provides a means to measure the relative abundance of two species in a given sample.

By analogy similar known methods from other spectrographic techniques could be used to obtain a value for the “NCO-free percent” of the products of the invention.

The terms ‘a-grp free percent’ and ‘a-N-grp free percent’ are analogously defined to the term ‘NCO-free percent’ herein and similar methods can also be used to determine these values in a product of the invention.

Unless the context clearly indicates otherwise it will be understood that any parameters, properties or conditions indicated herein as being suitable for silane polyurethanes obtained and/or obtainable from step (2) in one embodiment of the process of the invention will also be suitable for other silane polymers obtained and/or obtainable from step (2) of the process of the invention (e.g. embodiments where the silane polymer is a silane polyester). To avoid unnecessary duplication these are not necessarily repeated again for these other embodiments.

Silane polyurethanes obtained from or obtainable from an embodiment of the process of the invention may have mass-average molar mass Mw of at least 500 g/mol, as measured by means of GPC (gel permeation chromatography), preferably between 800 and 50000 g/mol, or between 800 and 6000 g/mol, or more preferably between 900 and 2400 g/mol.

Within the context of the invention silane polyurethanes of the invention include polymers of relatively low molar mass, also called oligomers. Compared to low molar mass compounds, such polyurethanes will result in different properties of a cured coating. A person skilled in the art will be able to select suitable ingredients to use in the process or steps of the invention, or a mixture of such compounds, depending on the desired performance of the end product.

The polymeric silane polyurethanes of the invention are preferably essentially amorphous, and have glass transition temperatures, as measured by DSC (differential thermal analysis, scan rate 10° C./min), of preferably between −150 and 100° C., more preferably between −120 and 80° C.

Products of the invention may also have a balance of low viscosity, high hardness and high flexibility.

Advantageously the product of the invention has a viscosity of less than 2500 mPas, more preferably less than 1700 mPas, most preferably less than 700 mPas.

Preferred products of the invention form coatings which when tested (in the test as described herein, i.e. at 750 g load) have a pencil hardness of at least 7H, more preferably 8H.

Preferred products of the invention form coatings which when tested herein have a flexibility visually assessed to be at least 4, more preferably 5.

Conveniently the products of the invention have a combination of the high flexibility, high hardness and low viscosity satisfying the values described herein

Although it is envisaged that the silane functional polyurethane oligomers of the invention can be used in the pure form, i.e. in the absence of a solvent and as the only binder, it is also possible to dilute the oligomer(s) with solvent and/or combine them with other polymeric binders to form compositions of the present invention. It is preferred to dilute the oligomers of the invention with a protic solvent.

The silane functional polyurethanes of the invention may be dispersed (or emulsified) in water using techniques well known in the art. This may optionally requires the use of an external surfactant (a type of dispersing agent) when being dispersed into water. Surfactants and or high shear can be utilised in order to assist dispersion of the Silane functional polyurethanes in water. Other protic solvents may be used.

Suitable surfactants include but are not limited to conventional anionic, cationic and/or non-ionic surfactants such as Na, K and NH₄ salts of dialkylsulphosuccinates, Na, K and NH₄ salts of sulphated oils, Na, K and NH₄ salts of alkyl sulphonic acids, Na, K and NH₄ alkyl sulphates, alkali metal salts of sulphonic acids; fatty alcohols, ethoxylated fatty acids and/or fatty amides, and Na, K and NH₄ salts of fatty acids such as Na stearate and Na oleate. Other anionic surfactants include alkyl or (alk)aryl groups linked to sulphonic acid groups, sulphuric acid half ester groups (linked in turn to polyglycol ether groups), phosphonic acid groups, phosphoric acid analogues and phosphates or carboxylic acid groups. Cationic surfactants include alkyl or (alk)aryl groups linked to quaternary ammonium salt groups. Non-ionic surfactants include polyglycol ether compounds and polyethylene oxide compounds. The surfactants may also be polymeric surfactants which are also described as wetting agents.

If used, the amount of total surfactants used is preferably at least 0.1%, more preferably at least 1% by weight, most preferably at least 3% by weight and preferably less than 11%, more preferably less than 9% and most preferably less than 7% by weight based on the weight of the total resin material. Preferably a mixture of anionic and non-ionic surfactants are used.

Dispersing resins (another type of dispersing agent) such as W-3000 available from Perstorp or as described in EP 1870442 could also be employed instead of or in combination with more conventional surfactants.

To control viscosity an organic solvent may optionally be added before, during and/or after the process for making the silane functional polyurethanes. Examples of solvents include water-miscible solvents such as propylene glycol based solvents, especially propylene glycol mono methyl ether and dipropylene glycol mono methyl ether and glycol ethers such as butyldiglycol. Optionally no organic solvents are added.

A co-solvent, as is well known in the coating art, is an organic solvent employed in an aqueous composition to ameliorate the drying characteristics thereof, and in particular to lower its minimum film forming temperature. The co-solvent may be solvent incorporated or used during preparation of the silane functional polyurethanes or may have been added during formulation of the aqueous composition.

An advantage of the current invention is that co-solvent can, as is often required for environmental and safety reasons, be present at a very low concentrations because of the nature of the silane functional polyurethanes.

Preferably the (optionally aqueous) coating composition comprising the silane functional polyurethanes has a co-solvent content <15 wt %, more preferably <10 wt % and especially <5 wt % by weight of solids.

Preferably the (optionally aqueous) coating composition comprising the silane functional polyurethanes has a co-solvent content >0 wt %, more preferably >0.5 wt %, most preferably >1 wt % and especially >2% by weight of solids.

Another aspect of the invention broadly provides a coating composition comprising the polymers and/or products of the present invention and/or as described herein. Compositions of the invention may also be used as sealants.

A further aspect of the invention provides a coating (and/or sealant) obtained or obtainable from a coating composition of the present invention.

A yet other aspect of the invention broadly provides a substrate and/or article having coated thereon an (optionally cured) coating composition of the present invention. In a preferred embodiment the coated substrate is scratch resistant and/or substantially transparent, the coating composition is a clear coat and/or the article is a display device.

Optionally the display device is suitable for an electronic device such as a computer screen, TV or monitor screen, laptop and/or mobile device such as phone or tablet computer.

A still further aspect of the invention broadly provides any of the aforementioned electronic devices comprising a display and/or other coating of the invention.

A yet further aspect of the invention broadly provides a method of using polymers and/or products of the present invention and/or as described herein to prepare a coating composition.

A still further aspect of the invention broadly provides a method for preparing a coated substrate and/or article comprising the steps of applying a coating composition of the present invention to the substrate and/or article and optionally curing said composition in situ to form a cured coating thereon. The curing may be by any suitable means, such as thermally, by radiation and/or by use of a cross-linker.

The polymer, products and/or compositions of the present invention may be used in many fields for example as coatings for industrial metal, industrial plastic coatings and flooring. They may also be used to prepare scratch resistant (optionally clear) coatings suitable for use as protective coatings for displays.

Preferred coating compositions are solvent coating compositions or aqueous coating compositions, more preferably are aqueous coating compositions.

Optionally aqueous coating compositions may also comprise a co-solvent. A co-solvent, as is well known in the coating art, is an organic solvent employed in an aqueous composition to ameliorate the drying characteristics thereof, and in particular to lower its minimum film forming temperature. The co-solvent may be solvent incorporated or used during preparation of polymers of the invention or may have been added during formulation of the aqueous composition.

The coating composition of the invention is particularly useful as or for providing the principle component of coating formulations (i.e. composition intended for application to a substrate without further treatment or additions thereto) such as protective or decorative coating compositions (for example paint, lacquer or varnish) wherein an initially prepared composition optionally may be further diluted with water and/or organic solvents, and/or combined with further ingredients or may be in more concentrated form by optional evaporation of water and/or organic components of the liquid medium of an initially prepared composition.

The coating composition of the invention may be applied to a variety of substrates including wood, board, metals, stone, concrete, glass, cloth, leather, paper, plastics, foam and the like, by any conventional method including brushing, dipping, flow coating, spraying, and the like. The coating composition of the invention may also be used to coat the interior and/or exterior surfaces of three-dimensional articles. The carrier medium may be removed by natural drying or accelerated drying (by applying heat) to form a coating.

The coating composition of the invention may contain other conventional ingredients including pigments, dyes, emulsifiers, surfactants, plasticisers, thickeners, heat stabilisers, levelling agents, anti-cratering agents, fillers, sedimentation inhibitors, UV absorbers, antioxidants, dispersants, reactive diluents, waxes, neutralising agents, adhesion promoters, defoamers, co-solvents, wetting agents and the like introduced at any stage of the production process or subsequently. It is possible to include fire retardants (such as antimony oxide) to enhance the fire retardant properties.

The compositions of the invention are preferably non-adhesive compositions. As used herein the term ‘non-adhesive composition’ denotes any composition that does not remain substantially tacky after drying under ambient conditions for a length of time which would be commercially acceptable. Preferred non-adhesive compositions are those which have a tack-free time of less than 16 hours. Tack-free time may conveniently be measured as described herein.

Polymers of the present invention may be prepared by one or more suitable polymer precursor(s) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated herein.

Polymer precursors of the invention may comprise one or more monomer(s), oligomer(s), polymer(s); mixtures thereof and/or combinations thereof which have suitable polymerisable functionality.

A monomer is a substantially monodisperse compound of a low molecular weight (for example less than one thousand daltons) which is capable of being polymerised.

A polymer is a polydisperse mixture of macromolecules of large molecular weight (for example many thousands of daltons) prepared by a polymerisation method, where the macromolecules comprises the multiple repetition of smaller units (which may themselves be monomers, oligomers and/or polymers) and where (unless properties are critically dependent on fine details of the molecular structure) the addition or removal one or a few of the units has a negligible effect on the properties of the macromolecule.

A oligomer is a polydisperse mixture of molecules having an intermediate molecular weight between a monomer and polymer, the molecules comprising a small plurality of monomer units the removal of one or a few of which would significantly vary the properties of the molecule. Preferably the term oligomer as used herein refers to a polydisperse mixture of molecules having a theoretical number average molecular weight (e.g. as determined by the Fox equation) of less than 10000 daltons, more preferably less than 5000 daltons, most preferably less than 3000 daltons.

Depending on the context a skilled person will be understand that the term polymer as used herein may or may not encompass oligomer.

The polymer precursor of and/or used in the invention may be prepared by direct synthesis or (if the polymeric precursor is itself polymeric) by polymerisation. If a polymerisable polymer is itself used as a polymer precursor of and/or used in the invention it is preferred that such a polymer precursor has a low polydispersity, more preferably is substantially monodisperse, to minimise the side reactions, number of by-products and/or polydispersity in any polymeric material formed from this polymer precursor. The polymer precursor(s) may be substantially un-reactive at normal temperatures and pressures.

Except where indicated herein polymers and/or polymeric polymer precursors of and/or used in the invention can be (co)polymerised by any suitable means of polymerisation well known to those skilled in the art. Examples of suitable methods comprise: thermal initiation; chemical initiation by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross-linking with such other resins as appropriate.

As used herein the term polyurethane denotes a polymer (and/or oligomer as the context dictates) comprising macromolecules comprising a plurality of trivalent or divalent amide moieties (i.e. ˜NR′(C═O)O˜ also referred to herein as urethane groups or urethane linkages). R′ may independently represent a bond, H or optionally substituted C₁₋₁₀hydrocarbo, preferably H or C₁₋₆alkyl, more preferably H).

As used herein the term silane polyurethane denotes a polymer (and/or oligomer as the context dictates) comprising macromolecules with a plurality of urethane linkages and one or more divalent silenyl moeities (e.g. ˜Si(R″)₂)Si˜, where each R″ may independently represent a bond, H or optionally substituted C₁₋₁₀hydrocarbo, preferably H or C₁₋₆alkyl, more preferably H).

As used herein the term silane polyester denotes a polymer (and/or oligomer as the context dictates) comprising macromolecules with a plurality of carboxycarbonyl linkages and one or more divalent silenyl moeities (e.g. ˜Si(R″)₂)Si˜, where each R″ may independently represent a bond, H or optionally substituted C₁₋₁₀hydrocarbo, preferably H or C₁₋₆alkyl, more preferably H).

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen and/or sulphur, more preferably from hydrogen, nitrogen, oxygen and/or sulphur.

The term ‘hydrocarbo group’ as used herein is a sub-set of an organic group and denotes any univalent or multivalent moiety (optionally attached to one or more other moieties) which consists of one or more hydrogen atoms and one or more carbon atoms. Hydrocarbo groups may comprise one or more of the following groups. Hydrocarbyl groups comprise univalent groups formed by removing a hydrogen atom from a hydrocarbon. Hydrocarbylene groups comprise divalent groups formed by removing two hydrogen atoms from a hydrocarbon the free valences of which are not engaged in a double bond. Hydrocarbylidene groups comprise divalent groups (represented by “R2C═”) formed by removing two hydrogen atoms from the same carbon atom of a hydrocarbon, the free valences of which are engaged in a double bond. Hydrocarbylidyne groups comprise trivalent groups (represented by “RCE”), formed by removing three hydrogen atoms from the same carbon atom of a hydrocarbon the free valences of which are engaged in a triple bond. Hydrocarbo groups may also comprise any saturated, unsaturated double and/or triple bonds (e.g. alkenyl, and/or alkynyl respectively) and/or aromatic groups (e.g. aryl) and where indicated may be substituted with other functional groups.

Most preferably organic or other groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic or other groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group):

The term ‘alkyl’ or its equivalent (e.g. ‘alk’) as used herein may be readily replaced, where appropriate and unless the context clearly indicates otherwise, by terms encompassing any other hydrocarbo group such as those described herein.

Silicon containing species may be referred to herein by analogous terms to any of those terms described herein that referring to carbon containing species. For example the term ‘silyl’ or its equivalent (e.g. ‘sil’) as used herein may be readily replaced, where appropriate and unless the context clearly indicates otherwise, by terms encompassing any other hydrosilo group such as those described herein (such as silane which is analogous to alkane).

The term “oxirane” is understood to mean a compound or a mono or multivalent radical comprising at least one 3 or 4 member cycloalkyl ether ring, that is to say at an epoxy or an oxetanyl radical or compound. Oxirane may also be abbreviated herein to “Oxir” or Oxir-group. Groups that may react under the conditions of the process of the invention with Oxir-groups may be referred to herein as reactive-oxirane groups also abbreviated herein to “r-Oxir” or “r-Oxir-group”. Examples of suitable r-Oxir groups are carboxy groups.

The term “epoxy” is understood to mean a compound or a mono or multivalent radical of general formula:

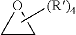

where each R′ independently on the same moiety represents any effective optionally substituted linking bond, H and/or organo group.

The term “oxetanyl” is understood to mean a compound or a mono or multivalent radical of general formula:

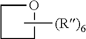

where each R″ independently on the same moiety represents any effective optionally substituted linking bond, H and/or organo group.

The term lactone as used herein denotes species comprising a cyclic mono ester or radical moiety thereof, i.e. where the ring has one ˜(C═O)O˜ divalent radical forming part of the ring.

The term lactam as used herein denotes species comprising a cyclic mono amide or radical moiety thereof, i.e. where the ring has one ˜(C═O)NZ˜ divalent radical forming part of the ring, where Z is a linking bond, H or organo group, more preferably H or C₁₋₁₀hydrocarbo, more preferably H or C₁₋₄alkyl, most preferably is H. It will be understood in the context of the process of the present invention Z is liable in the reactions described herein.

Any substituent, group or moiety mentioned herein refers to a monovalent species unless otherwise stated or the context clearly indicates otherwise (e.g. an alkylene moiety may comprise a bivalent group linked two other moieties). A group which comprises a chain of three or more atoms signifies a group in which the chain wholly or in part may be linear, branched and/or form a ring (including spiro and/or fused rings). The total number of certain atoms is specified for certain substituents for example C₁₋ₘorgano, signifies an organic group having from 1 to m carbon atoms. In any of the formulae herein if one or more ring substituents are not indicated as attached to any particular atom on the ring, the substituent may replace any hydrogen atom attached to a ring atom and may be located at any available position on the ring which is chemically suitable.

Preferably any of organic or other groups listed above comprise from 1 to 36 carbon atoms, more preferably from 1 to 18. It is particularly preferred that the number of carbon atoms in an organic group is from 1 to 10 inclusive.

Unless the context clearly indicates otherwise, as used herein plural forms of the terms herein are to be construed as including the singular form and vice versa.

The term ‘effective’ (for example with reference to the process, uses, products, materials, compounds, monomers, oligomers, polymer precursors and/or polymers of the present invention) will be understood to refer to those ingredients which if used in the correct manner provide the required properties to the material, compound, composition, monomer, oligomer, polymer precursor and/or polymer to which they are added and/or incorporated in any one or more of the uses and/or applications described herein. As used herein the term “suitable” denotes that a functional group is compatible with producing an effective product.

The substituents on the repeating unit may be selected to improve the compatibility of the materials with the polymers and/or resins in which they may be formulated and/or incorporated to form an effective material. Thus, the size and length of the substituents may be selected to optimise the physical entanglement or interlocation with the resin or they may or may not comprise other reactive entities capable of chemically reacting and/or cross-linking with such other resins.

Certain moieties, species, groups, repeat units, compounds, oligomers, polymers, materials, mixtures, compositions and/or formulations which comprise some or all of the invention as described herein may exist as one or more stereoisomers (such as enantiomers, diastereoisomers, geometric isomers, tautomers and/or conformers), salts, zwitterions, complexes (such as chelates, clathrates, crown compounds, cyptands/cryptades, inclusion compounds, intercalation compounds, interstitial compounds, ligand complexes, non-stoichiometric complexes, organometallic complexes, Tr-adducts, solvates and/or hydrates); isotopically substituted forms, polymeric configurations [such as homo or copolymers, random, graft or block polymers, linear or branched polymers (e.g. star and/or side branched polymers), hyperbranched polymers and/or dendritic macromolecules (such as those of the type described in WO 93/17060), cross-linked and/or networked polymers, polymers obtainable from di and/or tri-valent repeat units, dendrimers, polymers of different tacticity (e.g. isotactic, syndiotactic or atactic polymers)]; polymorphs [such as interstitial forms, crystalline forms, amorphous forms, phases and/or solid solutions] combinations thereof where possible and/or mixtures thereof. The present invention comprises all such forms which are effective.

Unless the context clearly indicates otherwise, as used herein plural forms of the terms herein are to be construed as including the singular form and vice versa.

The term “comprising” as used herein will be understood to mean that the list following is non exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises use in coatings, especially in scratch resistant coatings.

In the discussion of the invention herein, unless stated to the contrary, the disclosure of alternative values for the upper and lower limit of the permitted range of a parameter coupled with an indicated that one of said values is more preferred than the other, is to be construed as an implied statement that each intermediate value of said parameter, lying between the more preferred and less preferred of said alternatives is itself preferred to said less preferred value and also to each less preferred value and said intermediate value.

For all upper and/or lower boundaries of any parameters given herein, the boundary value is included in the value for each parameter. It will also be understood that all combinations of preferred and/or intermediate minimum and maximum boundary values of the parameters described herein in various embodiments of the invention may also be used to define alternative ranges for each parameter for various other embodiments and/or preferences of the invention whether or not the combination of such values has been specifically disclosed herein.

It will be understood that the total sum of any quantities expressed herein as percentages cannot (allowing for rounding errors) exceed 100%. For example the sum of all components of which the composition of the invention (or part(s) thereof) comprises may, when expressed as a weight (or other) percentage of the composition (or the same part(s) thereof), total 100% allowing for rounding errors. However where a list of components is non exhaustive the sum of the percentage for each of such components may be less than 100% to allow a certain percentage for additional amount(s) of any additional component(s) that may not be explicitly described herein.

The term “substantially” as used herein may refer to a quantity or entity to imply a large amount or proportion thereof. Where it is relevant in the context in which it is used “substantially” or “substantially the same as” can be understood to mean quantitatively (in relation to whatever quantity or entity to which it refers in the context of the description) there comprises an proportion of at least 80%, preferably at least 85%, more preferably at least 90%, most preferably at least 95%, especially at least 98%, for example about 100% of the relevant whole (or other reference as described herein). By analogy the term “substantially-free” may similarly denote that quantity or entity to which it refers comprises no more than 20%, preferably no more than 15%, more preferably no more than 10%, most preferably no more than 5%, especially no more than 2%, for example about 0% of the relevant whole (or other reference as described herein).

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination. Many other variations embodiments of the invention will be apparent to those skilled in the art and such variations are contemplated within the broad scope of the present invention. Further aspects of the invention and preferred features thereof are given in the claims herein.

Unless otherwise indicated all the tests herein are carried out under standard conditions as also defined herein.

### Assessment of Coating

Where indicated in some of the above tests, the performance of a coating can be assessed by assessing the damage to the coating. Damage is preferably assessed either by measuring the weight percentage of the coating left on the substrate after the test but the coating can also be evaluated visually using the rating scale below where 5 is the best and 1 is the worse:

5=very good: no visible damage or degradation/discoloration;
4=only slight visible damage or haze/blooming;
3=clear damage or haze/blooming;
2=coating partially dissolved/damaged;
1=very poor; coating is completely dissolved/damaged

### Hardness

Hardness may be determined herein using the conventional pencil hardness test and/or as a König hardness.

### Pencil Hardness

May be determined following (ASTM D3363-05(2011)e1) where the value of the test is given as the highest hardness pencil used in the test (at 750 g load) which after testing the coating is substantially unchanged (i.e. assessed as 5 in the ratings described herein).

König hardness

Can be determined following DIN 53157 NEN 5319 using an Erichsen hardness equipment where the values are given in seconds (s). Preferred coating compositions of the invention have a König hardness of at least 80 seconds after 5 weeks.

### Standard Conditions

As used herein, unless the context indicates otherwise, standard conditions (e.g. for drying a film) means a relative humidity of 50%±5%, ambient temperature (23° C.±2°) and an air flow of (less than or equal to) 0.1 m/s.

### Tack Free Time (TFT):

The tack free time can be determined by placing a piece of cotton wool (about 1 cm3, 0.1 g) on the drying film and placing a weight of 1 kg with a diameter 4.8 cm onto the piece of cotton wool (for 10 seconds). If the piece of cotton wool could be removed from the substrate by hand without leaving any wool or marks in or on the film, the film is considered to be tack free.

### EXAMPLES

The present invention will now be described in detail with reference to the following non limiting examples which are by way of illustration only.

### Example 1

### Using Ethylene Carbonate and HDI

To a reactor equipped with a stirrer and a condenser are charged 32.94 parts of ethylene carbonate. The reactor is heated to 35° C. To this are added over a period of 30 minutes 67.06 parts of aminopropyl trimethoxy silane. Initially the reaction heat produced will require cooling; later the mixture needs to be heated to keep a temperature of 35° C. After stirring at 35° C. for 2.5 hours, 65.72 parts of acetonitrile and 0.25 parts of stannous octoate are added. Next, 31.45 parts of hexane diisocyanate (HDI) are fed over a period of 30 minutes. During this feeding process and the subsequent reaction time, the temperature rises gradually to 65° C. At the end of the feed, the temperature is slowly increased to 80° C. and the mixture is stirred for 3 hours after which IR analysis shows complete reaction of the isocyanate groups. The final product is identified with NMR. Methanol is added to reach a final solids content of 57.9%.

### Example 2

### Using Ethylene Carbonate and TMXDI

To a reactor equipped with a stirrer and a condenser are charged 33.50 parts of ethylene carbonate. The reactor is heated to 35° C. To this are added over a period of 30 minutes 68.18 parts of aminopropyl trimethoxy silane. Initially the reaction heat produced will require cooling; later the mixture needs to be heated to keep a temperature of 35° C. After stirring at 35° C. for 2.5 hours, 33.70 parts of toluene and 0.25 parts of stannous octoate are added. Next, 46.48 parts of tetramethylxylylene diisocyanate (TMXDI) are fed over a period of 30 minutes. During this feeding process and the subsequent reaction time, the temperature rises gradually to 65° C. At the end of the feed, the temperature is slowly increased to 80° C. and the mixture is stirred for 90 minutes after which IR analysis shows complete reaction of the isocyanate groups.

The final product is identified with NMR. Methanol is added to reach a final solids content of 70%.

### Example 3

### Using Ethylene Carbonate and IPDI

To a reactor equipped with a stirrer and a condenser are charged 32.94 parts of ethylene carbonate. The reactor is heated to 35° C. To this are added over a period of 30 minutes 67.06 parts of aminopropyl trimethoxy silane. Initially the reaction heat produced will require cooling; later the mixture needs to be heated to keep a temperature of 35° C. After stirring at 35° C. for 2.5 hours, 50 parts of acetonitrile and 0.25 parts of stannous octoate are added. Next, 41.57 parts of isophorone diisocyanate (IPDI) are fed over a period of 30 minutes. During this feeding process and the subsequent reaction time, the temperature rises gradually to 47° C. At the end of the feed, the temperature is slowly increased to 90° C. and the mixture is stirred for 5 hours after which IR analysis shows complete reaction of the isocyanate groups. The final product is identified with NMR. The final product is identified with NMR.

Ethanol is added to reach a final solids content of 65%.

### Example 4

### Using Ethylene Carbonate and DesW

To a reactor equipped with a stirrer and a condenser are charged 32.94 parts of ethylene carbonate. The reactor is heated to 35° C. To this are added over a period of 30 minutes 67.06 parts of aminopropyl trimethoxy silane. Initially the reaction heat produced will require cooling; later the mixture needs to be heated to keep a temperature of 35° C. After stirring at 35° C. for 2.5 hours, 50 parts of acetonitrile and 0.25 parts of stannous octoate are added. Next, 48.25 parts of 4,4′-methylenedicyclohexyl diisocyanate (DesW) are fed over a period of 30 minutes. During this feeding process and the subsequent reaction time, the temperature rises gradually to 58° C. At the end of the feed, the temperature is slowly increased to 85° C. and the mixture is stirred for 4 hours after which IR analysis shows complete reaction of the isocyanate groups. The final product is identified with NMR. The final product is identified with NMR.

Methanol is added to reach a final solids content of 65%.

### Example 5

### Using Ethylene Carbonate and TDI

To a reactor equipped with a stirrer and a condenser are charged 32.94 parts of ethylene carbonate. The reactor is heated to 35° C. To this are added over a period of 30 minutes 67.06 parts of aminopropyl trimethoxy silane. Initially the reaction heat produced will require cooling; later the mixture needs to be heated to keep a temperature of 35° C. After stirring at 35° C. for 2.5 hours, 50 parts of acetonitrile and 0.25 parts of stannous octoate are added. Next, 32.54 parts of toluene diisocyanate (TDI) are fed over a period of 30 minutes. During this feeding process and the subsequent reaction time, the temperature rises gradually to 70° C. At the end of the feed, the temperature is slowly increased to 80° C. and the mixture is stirred for 4 hours after which IR analysis shows complete reaction of the isocyanate groups. The final product is identified with NMR. The final product is identified with NMR.

Ethanol is added to reach a final solids content of 68%.

### Film Properties

The urethane oligomers from Examples 1 and 2 above are formulated with 0.5 wt-% of titanium tetra iso-propoxide to form coating compositions. These are used to cast films on glass which are cured at 100° C. for 30 minutes.

The surface hardness of the films made from these Examples is determined by the pencil hardness test at a load of 750 g and the results are given below.

Pencil Hardness

### Example 1>8H

### Example 2>8H

Thus 8H means that the conventional pencil hardness method cannot distinguish between the hardness of Examples 1 or 2 determine an upper limit of their hardness. These results suggest that these films are exceptionally hard. They are also flexible thus achieving a good scratch resistance.

Example 2 is prepared from TMXDI (a di-isocyanate that typically forms very hard films in other compositions) whereas Example 1 is prepared from HDI (a di-isocyanate that typically forms very soft films). Yet both films have very high hardness. This shows that a wide variety of polyisocyanates might be used to prepare products of the invention without causing significant loss of the desired hardness of coatings made from them.

1. A process for preparing a silane polymer, the process comprising the steps of:
1) reacting
(i) a first component (=Silane Component I) comprising at least one silyl group(s) and at least one reactive group(s) A (Group A); with
(ii) a second component (=Cyclic Component II) comprising at least one organo cyclic moeit(ies) and at least one reactive group(s) B (Group B) reactive with Group A,
to form an intermediate product (=Silane Intermediate);
where at least one of the Silane Component I and/or the Cyclic Component II comprise at least one active-reactive group(s) and/or precursors therefor (r-grp(s));
where Group A and Group B are selected to react with each other under the conditions of step (1) to form the Silane Intermediate; and
where the Silane Intermediate comprises at least one silyl group(s), at least one organo moeit(ies) derived from the at least one organo cyclic moeit(ies) from Cyclic Component II and at least one r-grp(s); and
2) reacting the Silane Intermediate from step (1) with at least one reagent (=Active-Component III), comprising a plurality of active-groups (=a-grps) to form a polymeric product (=a Silane Polymer) that is substantially free (calculated with respect to Active-Component III) of a-grps;
where in step (2), the total moles of the r-grp(s) on the Silane Intermediate are at least substantially the same as the total moles of a-grps comprising the Active-Component III.

2. A process according to claim 1, in which group A comprises, preferably consists of, the at least one silyl group on component (i).

3. A process according to claim 1, in which group B comprises, preferably consists of, the at least one organo cyclic moiety on component (ii).

4. A process according to claim 2 in which in step (1) at least one silyl group on component (i) (=group A) reacts with the at least one organo cyclic moiety on component (ii) (=group B) by a ring opening of the cyclic moiety, to form the Silane Intermediate.

5. A process according to claim 1 in which the Silane Intermediate from step (1) is used directly in step (2) without isolation.

6. A process according to claim 1 in which the Silane Component I is selected from the group consisting of:
3-aminopropyltrimethoxysilane, 3-aminopropyltriethoxysilane,
3-aminopropylmethyldimethoxysilane, 3-aminopropylmethyldiethoxysilane,
3-aminopropylethyldiethoxysilane, 3-aminopropyldimethylethoxysilane,
3-aminopropyldiisopropylethoxysilane, 3-aminopropyltripropoxysilane,
3-aminopropyltributoxysilane, 3-aminopropylphenyldiethoxysilane,
3-aminopropylphenyldimethoxysilane,
3-aminopropyltris(methoxyethoxyethoxy)silane,
2-aminoisopropyltrimethoxysilane, 4-aminobutyltrimethoxysilane,
4-aminobutyltriethoxysilane, 4-aminobutylmethyldimethoxysilane,
4-aminobutylmethyldiethoxysilane, 4-aminobutylethyldimethoxysilane,
4-aminobutylethyldiethoxysilane, 4-aminobutyldimethylmethoxysilane,
4-aminobutylphenyldimethoxysilane, 4-amino-butylphenyldiethoxysilane,
4-amino(3-methylbutyl)methyldimethoxysilane,
4-amino(3-methylbutyl)methyldiethoxysilane,
4-amino(3-methylbutyl)trimethoxysilane,
3-aminopropylphenylmethyl-n-propoxysilane,
3-aminopropylmethyldibutoxysilane, 3-aminopropyldiethylmethylsilane,
3-aminopropylmethylbis(trimethylsiloxy)silane,
11-aminoundecyltrimethoxysilane, N-methyl-3-aminopropyltriethoxysilane,
N-(n-butyl)-3-aminopropyltrimethoxysilane,
N-(2-aminoethyl)-3-aminopropyltrimethoxysilane,
N-(2-aminoethyl)-3-aminoisobutylmethyldimethoxysilane,
N-(2-aminoethyl)-3-aminopropylmethyldimethoxysilane,
N-(2-aminoethyl)-3-aminopropyltris(2-ethylhexoxy)silane,
N-(6-aminohexyl)-3-aminopropyltrimethoxysilane,
N-benzyl-N-(2-aminoethyl)-3-aminopropyltrimethoxysilane,
bis(3-trimethoxysilylpropyl)amine, bis(3-triethoxysilylpropyl)amine,
(aminoethylaminomethyl)phenethyltrimethoxysilane,
3-(m-amino-phenoxy)propyltrimethoxysilane, m- and/or
p-aminophenyltrimethoxysilane,
3-(3-aminopropoxy)-3,3-dimethyl-1-propenyltrimethoxysilane,
3-aminopropylmethylbis(trimethylsiloxy)silane,
3-aminopropyltris(trimethylsiloxy)silane, 3-aminopropylpentamethyldisiloxane,
N, N-bis-(3-trialkoxysilylpropyl)-amine
and/or any suitable mixtures thereof.

7. A process according to claim 1 in which the Cyclic Component II is selected from one or more cyclic anhydride;
the at least one active-reactive group (r-grp) on the Silane Intermediate obtained from step (1) comprises, preferably consists of, oxirane-reactive group(s) (=r-Oxir) (preferably carboxy groups);
the plurality of active-groups on the Active-Component III in step (2) comprises, preferably consists of, two or more oxirane groups (Oxir) (preferably two or more epoxy groups); and
the Silane Polymer obtained from step (2) is a Silane Polyester; where
the molar ratio of the r-Oxir and Oxir groups are such that the Silane Polyester obtained from step (2) is substantially free of Oxir groups thereon.

8. A process according to claim 1 in which the Cyclic Component II is selected from one or more cyclic carbonate, (cyclic) lactone and/or (cyclic) lactam.

9. A process according to claim 8 in which the Cyclic Component II is a cyclic carbonate selected from the group consisting of:
1,3-dioxolan-2-one, 4-methyl-1,3-dioxolan-2-one, 4-ethyl-1,3-dioxolan-2-one, 4,5-dimethyl-1,3-dioxolan-2-one, 4,4-dimethyl-1,3-dioxolan-2-one, 4-hydroxymethyl-1,3-dioxolan-2-one, 4-phenoxymethyl-1,3-dioxolan-2-one, 1,3-dioxan-2-one; 5,5-dimethyl-1,3-dioxan-2-one, 5-methyl-5-propyl-1,3-dioxan-2-one, 5-ethyl-5-(hydroxymethyl)-1,3-dioxan-2-one; 4-isopropyl-5,5-dimethyl-1,3-dioxan-2-one; 4-tert-butyl-5-methyl-1,3-dioxan-2-one; 2,4-dioxaspiro[5.5]undecan-3-one;
and/or any suitable mixtures thereof.

10. A process according to claim 8, in which
the at least one active-reactive group (r-grp) on the Silane Intermediate obtained from step (1) comprises, preferably consists of, isocyanate reactive group(s) (=rNCO);
the plurality of active-groups on the Active-Component III in step (2) comprises, preferably consists of, two or more isocyanate groups (NCO); and
the Silane Polymer obtained from step (2) is a Silane Polyurethane; where
the molar ratio of the rNCO and NCO groups are such that the Silane Polyurethane obtained from step (2) is substantially free of NCO groups thereon.

11. A process according to claim 10, in which:
in step (1) the Silane Component I is an aminoalkyl silane; the Cyclic Component II is a cyclic carbonate; and the isocyanate reactive group(s) (=rNCO) on the Silane Intermediate are hydroxyl group(s);
in step (2) the Active-N-Component III is a di-isocyanate; and
the molar ratio of the OH groups on the Silane Intermediate to the moles of diisocyanate is from 1.8 to 2.2 (preferably about 2.0); and the Silane Polyurethane obtained from step (2) is an alkoxy functional silane polyurethane substantially free of isocyanate groups.

12. A process according to claim 8 in which the Active-Component III is a polyisocyanate selected from the group consisting of:
ethylene diisocyanate, hexamethylene diisocyanate (HDI), isophorone diisocyanate (IPDI), cyclohexanediisocyanate, dicyclohexylmethane diisocyanate, xylylene diisocyanate, tetramethylxylene diisocyanate (TMXDI), phenylene diisocyanate, toluene diisocyanate (TDI), diphenylmethane diisocyanate, polymethylene polyphenyl polyisocyanates, diphenylmethane diisocyanate, isocyanatomethyl-1-methyl cyclohexyl isocyanate, naphthylene diisocyanate, methylene diphenyl diisocyanate (MDI), hydrogenated methylene diphenyl diisocyanate (hydrogenated MDI), isocyanatomethyl-methyl-cyclohexylisocyanate
and/or any suitable mixtures thereof.

13. A Silane Polymer obtained and/or obtainable by a process as claimed in claim 1.

14. A Silane Polymer as claimed in claim 13 which comprises a Silane Polyester and/or Silane Polyurethane.

15. A Silane Polymer as claimed in claim 14 which is a Silane Polyurethane.

16. A coating composition comprising a Silane Polymer as claimed in claim 13.

17. A method for preparing a coated substrate and/or article comprising the steps of:
a) applying a coating composition as claimed in claim 16 a substrate and/or article; and
b) optionally curing said composition in situ to form a cured coating hereon.

18. A coated substrate and/or article (optionally cured) obtained and/or obtainable from a method as claimed in claim 17.

19. Use of a Silane Polymer as claimed in claim 13, to prepare a coating composition and/or a coated substrate and/or article.
